(19) United States
(12) Patent Application Publication
(10) Pub. No.: US 2021/0385224 A1
(43) Pub. Date: Dec. 9, 2021

(54) METHOD AND SYSTEM FOR AUTHENTICATION DATA PASSING

(71) Applicant: Citrix Systems, Inc., Fort Lauderdale, FL (US)

(72) Inventors: Manbinder Pal Singh, Coral Springs, FL (US); Jacob Summers, Coral Springs, FL (US); Harsh Shah, Pompano Beach, FL (US); Rachelle Tobkes, Davie, FL (US)

(21) Appl. No.: 16/895,396

(22) Filed: Jun. 8, 2020

(51) Int. Cl. H04L 29/06

(52) U.S. Cl. CPC H04L 63/102; H04L 63/0861; H04L 63/20; H04L 63/0838; H04L 63/0853; H04L 63/0815

(57) ABSTRACT

Described embodiments provide systems and methods for sharing authentication data between devices for access to application or web resources. The access manager on a first device may receive a first request for a credential maintained at the first device. The credential may be to access a resource via a second device. The access manager may initiate, responsive to the request, a second request for an approval at the first device or the second device. The access manager may access, responsive to receiving the approval, the credential from a secure store. The secure store may securely maintain information of a plurality of credentials. The access manager may transmit the credential to the second device to authenticate a user to access the resource.

### FIELD OF THE DISCLOSURE

The present application generally relates to authenticating and/or approving access to resources, including but not limited to systems and methods for sharing authentication data between devices for access to application or web resources.

### BACKGROUND

Prior to accessing a resource, a user may be required to undergo an authentication process. The user may be prompted to provide user authentication data, information, and/or credentials. For instance, the user may manually enter the authentication data via a login or other user interface prior to obtaining access to the resource.

### SUMMARY

This Summary is provided to introduce a selection of concepts in a simplified form that are further described below in the Detailed Description. This Summary is not intended to identify key features or essential features, nor is it intended to limit the scope of the claims included herewith.

The present disclosure is directed towards systems and methods for sharing authentication data between devices for access to a resource. A user may be required to undergo authentication prior to accessing a resource via a second device (e.g., a desktop or laptop computer, a smartphone, and/or other computing devices). However, a first device (e.g., a desktop or laptop computer, a smartphone, and/or other computing devices) may already maintain, store, generate, and/or have access to user authentication data, information, factors, and/or credentials (e.g., one-time password (OTP) codes, authentication tokens, single sign-on (SSO) codes, time-based OTP (TOTP) codes, and/or other authentication data). In some systems, the user can enter the authentication data directly into the second device to access the application or web resource. In the systems and methods disclosed herein, the user can avoid the direct/manual entry of authentication information by utilizing, obtaining and/or sharing the authentication data maintained at, generated at, and/or accessible to the first device. The devices may securely share, access, store and/or maintain the authentication data and/or credentials. The devices may utilize said authentication data for accessing a resource via multiple devices (e.g., peer devices, or primary and secondary devices).

In some embodiments of the present solution, a secure messaging service (e.g., a cloud-based messaging system, wireless device-to-device communication arrangement, relay system, and so on) may be utilized to exchange, access, transfer, and/or transmit authentication data (or other data and/or information) between the devices. The authentication data and/or credentials may include information derived from key authentication data, OTP codes, TOTP codes, session cookies, and/or other authentication factors accessible to the device. In some embodiments, instead of or in addition to authentication data and/or credentials, information about a session (e.g., session cookie, session identifier, session state) can be exchanged, accessed, transferred, and/or shared between the devices. The authentication data and/or credentials may be stored or maintained in a secure store (e.g., secured keystore, secured keychain, and/or other secured credential storage systems) within and/or accessible to at least one of the devices. The secure store may maintain, store and/or generate information of a plurality of authentication factors and/or credentials. The authentication data and/or credentials may be utilized to access a resource or application via one or both of the devices.

In some embodiments, the user may utilize the authentication factors accessible to the first device to avoid the direct/manual entry of authentication data in the second device. Authentication data (e.g., information derived from key authentication material, or even information about an existing authenticated session) may be exchanged, accessed, transferred and/or transmitted between the devices to provide, populate, and/or fill-in authentication information (e.g., forms fields, cookies, and/or other authentication data) in a device and/or resource. Prior to providing access to the authentication information to a second device, user consent may be obtained via a request for approval at the first or the second device. The user consent and/or approval may comprise an approval via a personal identification number, a passcode, a fingerprint, a retinal pattern, a signature, a badge tap, an ID card, a face image, a quick response (QR) code scan, a device unlock mechanism, a voice signal, a user interface selection, a push notification, a text message, information extracted from biometric markers, proximity to the device, and/or other approval mechanisms. The approval and/or consent may be provided by the user and/or a resource authenticated by the user.

In some embodiments, a means for the devices to discover one another and establish a trusted connection prior to exchanging, sending, and/or transferring authentication data may be utilized. Some examples may include proximity sensing (e.g., via wireless communication or signatures) between the devices, proximity sensing (e.g., via biometrics) between the user and the devices, a QR code scan, and/or other mechanisms. Wireless transmitters (for example, software beacons) that transmit and/or broadcast signals and/or identifiers (e.g., RSSI signals) may be located on the devices. The transmitted signals may be recognized by an access manager on a device (e.g., an authenticator app, a Citrix workspace app (CWA), a SaaS application, and/or other applications or resources) and can be used to enable a trusted and/or secured connection between the devices. For example, if a second device is in close proximity to a first device, the devices may utilize this information to establish a trusted connection between the devices. In some embodiments, a user may utilize the first device to scan a QR code on the second device and thus enable a trusted connection between the devices.

In some embodiments, active authenticated user sessions (e.g., of the same web resource or application) via the first and second devices may exist or persist independently or irrespective from each other. For example, if an authenticated user session for a resource accessed via a first device is terminated, the authenticated user session for the same resource via a second device may remain active.

In some embodiments, a user that is already authenticated by an access manager on a first device may approach a second device. The access manager may be unrelated to the resource (e.g., not a counterpart or loyalty application of the resource) the user is authenticating to. The second device may present a logon/login page to access the resource via the second device. Device consent may be required to access the resource via the second device. For example, the first device may scan a QR code on the second device using the access manager (e.g., CWA) on the first device. Accordingly, the devices are made aware of one another and a trusted connection may be enabled between the devices. The access manager on the first device may then send, transmit, share and/or transfer information of one or a plurality of authentication credentials to the second device (e.g., to an access manager of the second device) via a secure messaging service. For example, a CWA on a first computing device may send one or a plurality of authentication credentials (e.g., an OTP code, a TOTP code, and/or other credentials) to a CWA on a second computing device via a cloud-based messaging system. The access manager on the second device may receive the information of the one or a plurality of credentials. The access manager on the second device may then authenticate the user to access the resource via the second device.

In some embodiments, a user may attempt to access a web resource and/or application (e.g., a web application, a URL, a webpage) via a second device. The web resource and/or application may require authentication data, information, factors, and/or credentials prior to obtaining access to the resource. For example, an access manager and/or browser agent (e.g., a web browser extension and/or a browser helper object (BHO)) may determine that an authentication credential (e.g., an OTP code, a TOTP code, a SSO code, and/or other credentials) is requested or required to access the resource. The user may enter one or more authentication credentials and/or factors (e.g., an account identifier, a user-name, a password) through the second device. The access manager on the second device may use a secure messaging service (e.g., a cloud-based messaging system) to obtain authentication credentials (e.g., an OTP code, a TOTP code, a SSO code, and/or other credentials) from the access manager on the first device. User consent and/or approval may be obtained prior to exchanging, sending, and/or transmitting data between the first and second devices. The approval and/or consent may be provided by the user. User approval and/or consent may be provided via a pin, a face image, a voice signal, and/or other approval mechanisms.

The access manager on the first device may send the authentication credential(s) to the access manager on the second device. The access manager on the second device may receive the authentication credential(s) and provide the information to the resource (e.g., web resource and/or application) to access the resource. For example, a BHO on the second device may receive and utilize an OTP code, TOTP code or SSO code to populate and/or fill-in information (e.g., forms fields, browser cookies, and/or other authentication data) requested by an access/login interface of a computing device, an application, and/or a web-resource. The second device may in this manner utilize the received authentication credential(s) and/or factor(s) to access the resource via the second device.

In some embodiments, a second device requesting authentication data, information, credential(s), and/or factor(s) from a first device may need to establish a trusted connection with the second device. A trusted and/or secured connection between the devices may enable the secure transmission or sharing of authentication information and/or credentials. Although the devices can establish a trusted and/or secured connection, automatic attempts by the devices to retrieve information may not be automatically granted or approved. For example, a second device may attempt to retrieve authentication data and/or credentials from the first device without user and/or device approval. The first device may deny providing the authentication data and/or credentials without user and/or device approval.

If a secure and/or trusted connection is not established between the devices, an additional device credential (e.g., a pin, a passcode, a fingerprint, a badge tap, a face image, and/or other credentials) may be utilized to enable the connection. In some embodiments, the device providing the authentication credential(s) may require user approval prior to sending, transmitting, and/or exchanging the authentication credentials. User approval may be obtained via a pin, a passcode, a fingerprint, a face image, a device unlock mechanism, a voice signal, a user interface selection and/or other approval mechanisms. In some embodiments, if a secure and/or trusted connection is established between the devices, the automatic transfer and/or exchange of authentication data, credentials, factors, and/or information may be configured between the devices.

In one aspect, the present disclosure is directed to a method for sharing authentication data between devices for access to a resource. The method may include receiving, by an access manager on a first device, a first request for a credential maintained at the first device. The first request for a credential may be directed to obtaining access to a resource via a second device. The access manager may initiate, responsive to the first request, a second request for an approval. The second request for an approval may be at the first device or the second device. The access manager, responsive to receiving the approval, may access the credential from a secure store. The secure store may securely maintain information of a plurality of credentials. The access manager may transmit the credential to the second device to authenticate a user to access the resource.

In some embodiments, the first device and the second device may be operated by the (e.g., same) user. In some embodiments, the second request may comprise a prompt to the user to provide the approval at the first device or the second device. The approval may comprise an approval via pin, a passcode, a fingerprint, a badge tap, a face image, a QR code scan, or a device unlock operation. The approval may comprise a voice signal, proximity to the first or second device, or a user interface selection.

In certain embodiments, the access manager may receive the first request via a secure messaging service. The access manager may transmit the credential to the second device via the secure messaging service. In some embodiments, the access manager may access the credential from the secure store. Accessing the credential from the secure store may comprise accessing the credential that is stored in the secure store. Accessing the credential from the secure store may comprise causing the secure store to generate the credential according to the information maintained by the secure store.

In some embodiments, the access manager may receive a third request for a second credential maintained at the first device, to access a second resource via a third device. The access manager, responsive to the request, may initiate a fourth request for a second approval at the first device. The access manager, responsive to a failure to receive the second approval, may send a response denying the third request for the second credential. In certain embodiments, the credential may comprise a OTP code, an authentication token, a SSO code, or a TOTP code. The credential may be one of a plurality of authentication factors to authenticate the user to access the resource.

In another aspect, the present disclosure is directed to a first device for sharing authentication data between devices for access to a resource. The first device may comprise at least one processor. The at least one processor may be configured to receive a first request for a credential maintained at the first device. The first request for a credential may be directed to obtaining access to a resource via a second device. The at least one processor may be configured to initiate, responsive to the first request, a second request for an approval at the first device or the second device. The at least one processor may be configured to access, responsive to receiving the approval at the first device, the credential from a secure store. The secure store may be configured to securely maintain information of a plurality of credentials. The at least one processor may be configured to transmit the credential to the second device to authenticate a user to access the resource.

In some embodiments, the first device, comprising at least one processor, and the second device are operated by the user. In certain embodiments, the second request may comprise a prompt to the user to provide the approval at the first device or the second device. The approval may comprise an approval via a pin, a passcode, a fingerprint, a badge tap, a face image, a QR code scan, or a device unlock operation. The approval may comprise a voice signal, proximity to the first or second device, or a user interface selection.

In certain embodiments, the at least one processor of the first device may be configured to receive, by the access manager, the first request via a secure messaging service. The at least one processor of the first device may be configured to transmit, by the access manager, the credential to the second device via the secure messaging service. The at least one processor of the first device may be configured to access the credential from the secure store. The at least one processor may access the credential from the secure store by accessing the credential that is stored in the secure store. The at least one processor may access the credential from the secure store by causing the secure store to generate the credential according to the information maintained by the secure store.

In some embodiments, the at least one processor of the first device may be configured to receive a third request for a second credential maintained at the first device. The third request for a second credential may be directed to obtaining access to a second resource via a third device. The at least one processor of the first device may be configured to initiate, responsive to the third request, a fourth request for a second approval at the first device. The at least one processor of the first device may be configured to send, responsive to a failure to receive the second approval, a response denying the third request for the second credential. In certain embodiments, the credential may comprise a OTP code, an authentication token, a single sign-on SSO code, or a TOTP code. The credential may be one of a plurality of authentication factors to authenticate the user to access the resource.

In yet another aspect, the present disclosure is directed to a non-transitory computer readable medium storing program instructions for causing at least one processor of a first device to share authentication data between devices for access to a resource. The program instructions may cause at least one processor of the first device to receive a first request for a credential maintained at the first device. The first request for a credential may be directed to obtaining access to a resource via a second device. The program instructions may cause at least one processor of the first device to initiate, responsive to the first request, a second request for an approval at the first device or the second device. The program instructions may cause at least one processor of the first device to access, responsive to receiving the approval, the credential from a secure store. The secure store may securely maintain information of a plurality of credentials. The program instructions may cause at least one processor of the first device to transmit the credential to the second device to authenticate a user to access the resource.

In some embodiments, the program instructions may cause at least one processor of the first device to receive the first request via a secure messaging service. The program instructions may cause at least one processor of the first device to transmit the credential to the second device via the secure messaging service.

### BRIEF DESCRIPTION OF THE FIGURES

The foregoing and other objects, aspects, features, and advantages of the present solution will become more apparent and better understood by referring to the following description taken in conjunction with the accompanying drawings, in which:

FIG. 1A is a block diagram of embodiments of a computing device;

FIG. 1B is a block diagram depicting a computing environment comprising client device in communication with cloud service providers;

FIG. 2 is a block diagram of an example system for sharing authentication data between devices for access to a resource.

FIG. 3 is a communication diagram of an embodiment for a system for sharing authentication data between devices for access to a resource.

FIG. 4 is a communication diagram of an embodiment for a system for sharing authentication data between devices for access to a resource.

FIG. 5 is a flow diagram of an embodiment of a method for sharing authentication data between devices for access to a resource.

The features and advantages of the present solution will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

For purposes of reading the description of the various embodiments below, the following descriptions of the sections of the specification and their respective contents may be helpful:

Section A describes a computing environment which may be useful for practicing embodiments described herein;

Section B describes embodiments of systems and methods for sharing authentication data between devices for access to a resource.

### A. Computing Environment

Prior to discussing the specifics of embodiments of the systems and methods of an appliance and/or client, it may be helpful to discuss the computing environments in which such embodiments may be deployed.

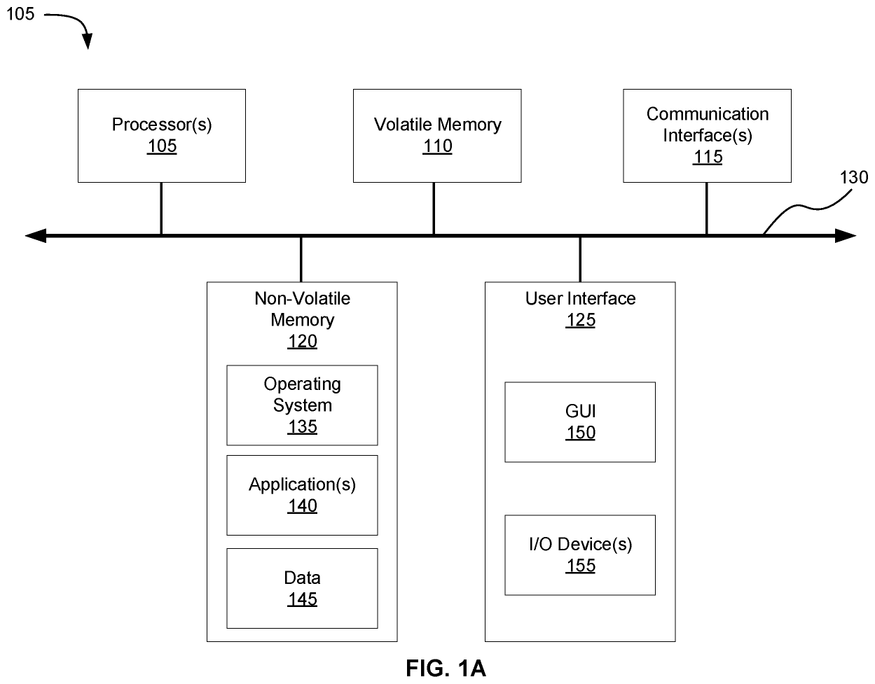

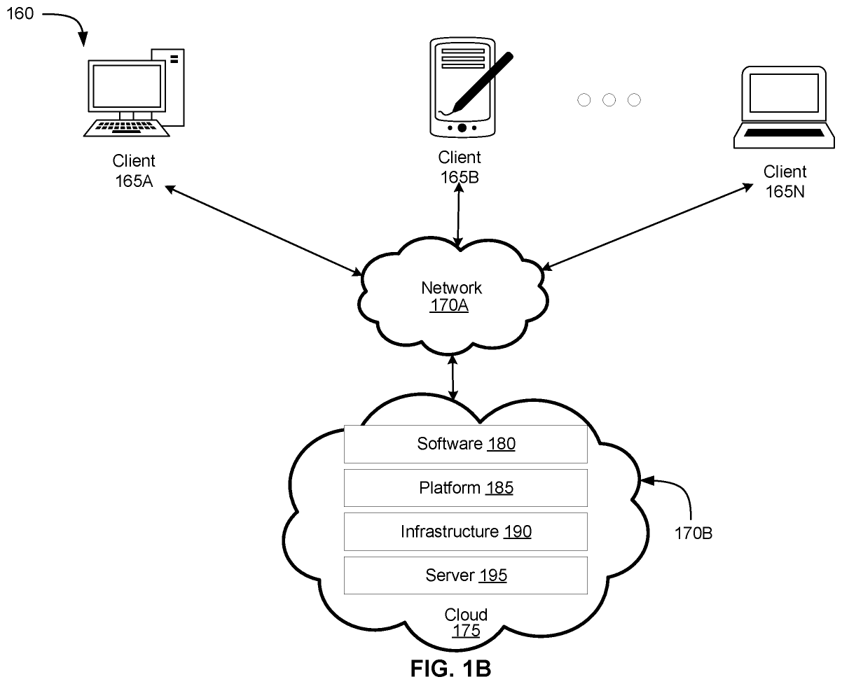

As shown in FIG. 1A, computer 100 may include one or more processors 105, volatile memory 110 (e.g., random access memory (RAM)), non-volatile memory 130 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 125, one or more communications interfaces 135, and communication bus 130. User interface 125 may include graphical user interface (GUI) 150 (e.g., a touchscreen, a display, etc.) and one or more input/output (I/O) devices 155 (e.g., a mouse, a keyboard, a microphone, one or more speakers, one or more cameras, one or more biometric scanners, one or more environmental sensors, one or more accelerometers, etc.). Non-volatile memory 130 stores operating system 135, one or more applications 140, and data 145 such that, for example, computer instructions of operating system 135 and/or applications 140 are executed by processor(s) 105 out of volatile memory 110. In some embodiments, volatile memory 110 may include one or more types of RAM and/or a cache memory that may offer a faster response time than a main memory. Data may be entered using an input device of GUI 150 or received from I/O device(s) 155. Various elements of computer 100 may communicate via one or more communication buses, shown as communication bus 130.

Computer 100 as shown in FIG. 1A is shown merely as an example, as clients, servers, intermediary and other networking devices and may be implemented by any computing or processing environment and with any type of machine or set of machines that may have suitable hardware and/or software capable of operating as described herein. Processor(s) 105 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A “processor” may perform the function, operation, or sequence of operations using digital values and/or using analog signals. In some embodiments, the “processor” can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors. A processor including multiple processor cores and/or multiple processors multiple processors may provide functionality for parallel, simultaneous execution of instructions or for parallel, simultaneous execution of one instruction on more than one piece of data.

Communications interfaces 135 may include one or more interfaces to enable computer 100 to access a computer network such as a Local Area Network (LAN), a Wide Area Network (WAN), a Personal Area Network (PAN), or the Internet through a variety of wired and/or wireless or cellular connections.

In described embodiments, the computing device 100 may execute an application on behalf of a user of a client computing device. For example, the computing device 100 may execute a virtual machine, which provides an execution session within which applications execute on behalf of a user or a client computing device, such as a hosted desktop session. The computing device 100 may also execute a terminal services session to provide a hosted desktop environment. The computing device 100 may provide access to a computing environment including one or more of: one or more applications, one or more desktop applications, and one or more desktop sessions in which one or more applications may execute.

Referring to FIG. 1B, a computing environment 160 is depicted. Computing environment 160 may generally be considered implemented as a cloud computing environment, an on-premises (“on-prem”) computing environment, or a hybrid computing environment including one or more on-prem computing environments and one or more cloud computing environments. When implemented as a cloud computing environment, also referred as a cloud environment, cloud computing or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include, but not limited to, networks, network bandwidth, servers, processing, memory, storage, applications, virtual machines, databases, software, hardware, analytics, and intelligence.

In embodiments, the computing environment 160 may provide client 165 with one or more resources provided by a network environment. The computing environment 165 may include one or more clients 165a-165n, in communication with a cloud 175 over one or more networks 170. Clients 165 may include, e.g., thick clients, thin clients, and zero clients. The cloud 108 may include back end platforms, e.g., servers, storage, server farms or data centers. The clients 165 can be the same as or substantially similar to computer 100 of FIG. 1A.

The users or clients 165 can correspond to a single organization or multiple organizations. For example, the computing environment 160 can include a private cloud serving a single organization (e.g., enterprise cloud). The computing environment 160 can include a community cloud or public cloud serving multiple organizations. In embodiments, the computing environment 160 can include a hybrid cloud that is a combination of a public cloud and a private cloud. For example, the cloud 175 may be public, private, or hybrid. Public clouds 108 may include public servers that are maintained by third parties to the clients 165 or the owners of the clients 165. The servers may be located off-site in remote geographical locations as disclosed above or otherwise. Public clouds 175 may be connected to the servers over a public network 170. Private clouds 175 may include private servers that are physically maintained by clients 165 or owners of clients 165. Private clouds 175 may be connected to the servers over a private network 170. Hybrid clouds 175 may include both the private and public networks 170 and servers.

The cloud 175 may include back end platforms, e.g., servers, storage, server farms or data centers. For example, the cloud 175 can include or correspond to a server or system remote from one or more clients 165 to provide third party control over a pool of shared services and resources. The computing environment 160 can provide resource pooling to serve multiple users via clients 165 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In embodiments, the computing environment 160 can provide on-demand self-service to unilaterally provision computing capabilities (e.g., server time, network storage) across a network for multiple clients 165. The computing environment 160 can provide an elasticity to dynamically scale out or scale in responsive to different demands from one or more clients 165. In some embodiments, the computing environment 160 can include or provide monitoring services to monitor, control and/or generate reports corresponding to the provided shared services and resources.

In some embodiments, the computing environment 160 can include and provide different types of cloud computing services. For example, the computing environment 160 can include Infrastructure as a service (IaaS). The computing environment 160 can include Platform as a service (PaaS). The computing environment 160 can include server-less computing. The computing environment 160 can include Software as a service (SaaS). For example, the cloud 175 may also include a cloud based delivery, e.g. Software as a Service (SaaS) 180, Platform as a Service (PaaS) 185, and Infrastructure as a Service (IaaS) 190. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 165 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 165 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 165 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 165 may also access SaaS resources through smartphone or tablet applications, including, e.g., Salesforce Sales Cloud, or Google Drive app. Clients 165 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

B. Systems and Methods for Sharing Authentication Data between Devices for Access to a Resource

The present disclosure is directed towards systems and methods for sharing authentication data between devices for access to a resource. A user may be required to undergo authentication prior to accessing a resource via a second device (e.g., a desktop or laptop computer, a smartphone, a tablet, a small form factor device, and/or other computing devices). Some examples of resources may include web applications, workspaces (e.g., Citrix Workspace App (CWA)), web applications via a workspace, software as a service (SaaS) applications, infrastructure as a service applications (IaaS), platform as a service applications (PaaS), Windows applications, Linux applications, file repositories, file sharing systems, and/or other applications or web resources.

However, a first device (e.g., a desktop or laptop computer, a smartphone, a tablet, a small form factor device, and/or other computing devices) may already maintain, store, generate, and/or have access to user authentication data, information, factors, and/or credentials. Some examples of authentication data comprise user-names, account identifiers, passwords, personal identification numbers, one-time password (OTP) codes, single sign-on (SSO) codes, time-based OTP (TOTP) codes, authentication tokens, security tokens, hardware tokens, software tokens, and/or other authentication data. In some systems, the user can enter or provide the requested authentication data directly into the second device to access the application or web resource.

In the systems and methods presented herein, the user can avoid entering authentication information in the second device by accessing, utilizing, obtaining, transferring and/or sharing the authentication data maintained at, generated at, and/or accessible to the first device. The systems and methods presented herein can result in for instance a 20% (or other percent) or more reduction of the access time of a web resource and/or application. The first device and the second device may be operated by the (e.g., same) user. The devices may securely store authentication data and can utilize said data for authentication purposes via multiple devices.

In some embodiments of the present solution, a secure messaging service (e.g., a cloud-based messaging system, relay system, or a direct wireless device-to-device communication arrangement) may be utilized to exchange, access, transfer, and/or transmit authentication data between the devices The authentication data and/or credentials may include information derived from key authentication data, OTP codes, TOTP codes, session cookies, and/or other authentication factors accessible to the device. The authentication data and/or credentials may be stored or maintained in a secure store within and/or accessible to the device. Some examples of a secure store can comprise a secured keystore, a secured keychain, a password management system, and/or other credential storage management systems. The secure store may reside in the first device or may be in communication with the first device (e.g., residing in another device such as a network device or appliance). The secure store may be accessed via software applications, cloud-based applications, hardware devices, and/or web-based services. The secure store may maintain, store and/or generate information of a plurality of authentication factors and/or credentials. The authentication data and/or credentials may be utilized to access a resource or application via a second device.

Accessing the authentication credential may comprise accessing the credential stored in the secure store. Alternatively, accessing the credential can comprise causing the secure store to generate the credential according to the information maintained by the secure store. For example, the secure store may be caused to generate a private key, certificate or other credential for accessing a resource via a second device based on stored account identifiers and/or passwords. The authentication credential may be one of a plurality of authentication factors to authenticate the user to access the resource. For example, a user-name, a password, and a one-time password (OTP) code may be associated with a resource, but only the OTP code may be obtained from the secure store (via the first device) to authenticate the user to access the resource.

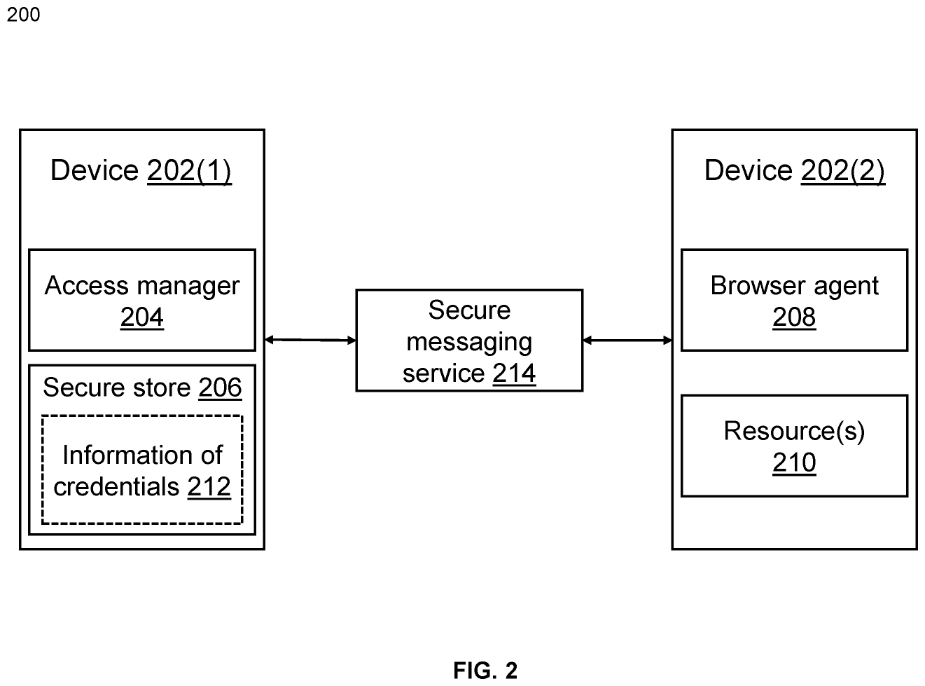

Referring to FIG. 2, depicted is a block diagram of one example embodiment of a system 200 for sharing authentication data between devices for access to a resource. The system 200 may include one or more devices 202 and/or secure messaging service(s) 214. A device 202 may include at least one access manager 204, secure store 206, browser agent 208, and can provide access to one or more resources 210. The secure store 206 may store or maintain information relating to a user's authentication credential(s) 212. In some embodiments, the secure store 206 may store or maintain the credential(s) 212.

The above-mentioned elements or entities are implemented in hardware, or a combination of hardware and software, in one or more embodiments. Components of the system 200 may be implemented using hardware or a combination of hardware or software detailed above in connection with FIGS. 1A and 1B. For instance, these elements or entities can include any application, program, library, script, task, service, process or any type and form of executable instructions executing on hardware of the client 165, the device(s) 202, the secure messaging service 214, and the network device(s) 306, among others. The hardware includes circuitry such as one or more processors in one or more embodiments.

The system 200 may include one or more devices 202. The device 202 may be configured and/or designed to provide an authenticated user with access to web resources or applications 210. The devices 202 may be operated (concurrently or otherwise) by a user. The device 202 may include or correspond to devices of a consumer of a service, resource, and/or application 210. For example, if the consumer is an individual or user, the device 202 may comprise a smartphone, a laptop (e.g., at home), a tablet device, and a desktop computer (e.g., at work), that the user may use to access a resource (e.g., Dropbox service) at various times and/or locations for instance. In an example where the consumer is an organization, such as an enterprise, the consumer can extend over a number of users (e.g., management persons, staff members, IT administrators, and so on) and their associated devices 202 (e.g., corporate-issued device, personally-owned devices, and/or registered/approved devices (e.g., in a BYOD program)). Multiple devices 202 may communicate with one another and/or work in conjunction to, for example, accelerate, protect and/or secure network 170 traffic.

In some embodiments, the device 202 may store, generate, and/or maintain authentication data, information, credentials, and/or factors 212 in a secure store 206. For example, a mobile device (or another computing device) may store, generate, and/or have access to an account identifier, a password, key material and/or an authentication token (or any other authentication data) that provide an authenticated user with access to a resource 210. The device 202 may obtain the authentication data from multiple sources that can include another device 202, a resource 210, a user, and/or other sources.

The device 202 may receive a request for the stored authentication credentials 212 from another device 202. The request for the stored authentication credentials 212 can comprise a request to access and/or utilize the credentials 212 for a web resource and/or application in a network and/or computer environment, such as a request for the authentication data to access the application resources via a portal page presented on another device's 202, and/or a request for the credentials 212 to access a SaaS application. For example, the user may attempt to access a web application (e.g., GitHub) via a second device (e.g., a mobile phone) and the web application (or another resource) may require user authentication. Hence, a first device (e.g., a laptop computer) may receive a request for the authentication credentials that are required by the web application from the second device. The request can initiate and/or originate from/with a device 202 that may request the authentication factors to access and/or utilize the service and/or resource via the second device 202. In some embodiments, the device 202 may receive the request for the stored credential via a pop-up message, a push notification, a secured messaging service, a cloud-based messaging service, a wired network, a wireless network, and/or other methods of communication. The data (e.g., an authentication credential, a request to access the authentication credentials) communicated, exchanged, transferred, shared and/or transmitted between the devices 202 may be secured and/or encrypted.

Responsive to the request for the credentials 212, the device 202 can initiate and/or originate a request for an approval (e.g., an approval from a user, and/or an approval from a device, application or resource 210 authenticated by the user) at the device 202. In some embodiments, an access manager 204 on a first device 202 may initiate a request for an approval at the first device 202 and/or a second device 202. The request for an approval may comprise a prompt to the user to provide the approval at the first and/or second device 202. For example, the user may receive a prompt at the first device 202 requesting approval to access and/or transmit a credential (e.g., a OTP code, a TOTP code, and/or other credentials) by providing a personal identification number, for instance. In other embodiments, the user may receive a prompt at the second device 202 requesting approval to access and/or send a credential by providing biometric information (e.g., a voice signal, a face image) through a peripheral interface (e.g., a device microphone, a device camera, a headset, a sensor or other input/detection device). The approval may comprise an approval via a personal identification number, a passcode, a fingerprint, a retinal pattern, a signature, a badge tap, an ID card, a face image, a QR code scan, a device unlock mechanism, a voice signal, a user interface selection, a push notification, a text message, information extracted from biometric markers, proximity to the device, and/or other approval mechanisms.

In response to receiving the approval, the device 202 can access the information of the credentials 212 from a secure store 206. In certain embodiments, the second device 202 may use the information of the credentials to access the resource 210. The secure store 206 can securely maintain information of a plurality of credentials 212. For example, the secure store 206 may maintain and/or store account identifiers, passwords, access tokens, and/or other authentication credentials for one or more resources 210. In some embodiments, the device 202 can access and/or obtain the information of the credential (e.g., a OTP code, a TOTP code, and/or other credentials) from a message or a stream of messages of a messaging service (e.g., short message service (SMS)). In response to a failure to receive an approval, the device 202 may send and/or transmit a response denying the request for the credentials 212. For example, the user may deny a request for approval (e.g., a prompt) to access a credential 212 (e.g., a OTP code, a TOTP code, and/or other credentials) by a second device 202, for instance. Responsive to failing to receive the approval, the first device 202 may send and/or transmit a response denying the request (e.g., a message, a pop-up, a push notification, and/or other response) to the second device 202 via a secure messaging service 214 (e.g., a cloud-based messaging system, relay device/service, or otherwise).

In certain embodiments, the device 202 may transmit, send, share and/or transfer the credentials 212 to another device 202 (e.g., via a secure messaging service 214) to authenticate a user to access a resource 210. For example, a first device 202 may transmit a SSO code (or other credentials 212) to a second device 202 to authenticate a user to access a IaaS, PaaS, SaaS, and/or other resources 210. The device 202 may use the credential(s) 212 (e.g., an access token, a OTP code, a TOTP code, a security certificate, an encryption key, a security key, and/or other credentials 212) to access the resource(s) 210. For instance, the device 202 may use a transmitted SSO code (or other credentials 212) to access the resource(s) 210 via a gateway service (e.g., CWA) or may access the resource 210 directly (e.g., SaaS). Once authenticated, the device 202 may be utilized by the user to access the resource 210. In some embodiments, the device 202 may re-authenticate the user by utilizing the transmitted credentials and/or sending a request to access the credentials 212 to a device that maintains the credentials 212.

In some embodiments, the device 202 can include, among other elements, an access manager 204, a secure store 206, a browser agent 208, and can provide access to one or more resources 210. The access manager 204 may be configured and/or designed to manage device 202 (or user) requests and/or manipulate the information of credentials 212. The access manager 204 may access, generate, establish, maintain, and/or modify authentication information of the user. The access manager 204 may control, manage, and/or authenticate the access of a device 202 and/or user to the resource 210 (e.g., web resources or applications). For example, the access manager 204 may establish and/or identify the type of access a user has to a resource 210 and the limits of said type of access. The type of access may include administrator access, user access, visitor access, and/or other types of access. In some embodiments, the access manager 204 may access, utilize and/or generate one or more authentication factors to authenticate a user. The access manager 204 may be installed on the device 202 and/or executed by the device 202 and may be accessed using an interface (e.g., a web browser). The access manager 204 may provide the user with an interface that enables access to the web resources or applications (e.g., SaaS applications, web applications, virtual application, desktop applications, mobile application, local applications, and/or other resources). Some examples of an access manager 204 can include an authenticator app (e.g., Google authenticator app, Microsoft authenticator app), a workspace app (e.g., Citrix workspace app (CWA)), and/or other types of applications or tools. The access manager 204 may be unassociated with a specific resource 210 (e.g., not an application solely dedicated to the resource 210). For example, the access manager 204 may authenticate the user and/or device to multiple resources 210. The access manager 204 on the first device, and the access manager 204 on the second device may have one or more different functionalities, capabilities and/or features.

In one embodiment, the access manager 204 on a device 202 may receive a first request for credentials 212 maintained and/or stored at the device 202. The access manager 204 on a first device may receive the request for credentials 212 responsive to a second device's 202 attempt to access a resource 210. In some embodiments, the access manager 204 of a first device 202 may communicate with the access manager 204 of a second device 202 to send, receive, and/or initiate requests between the devices 202. For example, the user may attempt to access a web application (e.g., GitHub) via a second device (e.g., a mobile phone) and the web application (or another resource 210) may require user authentication. Hence, the access manager 204 of a first device 202 (e.g., a laptop computer) may receive a request for the authentication credentials 212 from the access manager 204 (e.g., browser agent or login interface/agent) of the second device 202. The request can initiate and/or originate from/with an access manager 204 of the device 202. In some embodiments, the requests and credentials 212 may be received, transferred, transmitted, and/or exchanged via a secure messaging service 214 (e.g., a cloud-based messaging system, a secure channel), a pop-up message, a push notification, a wired network, a wireless network, and/or other methods of communication.

Responsive to the first request, the access manager 204 may initiate and/or originate a second request for an approval (e.g., an approval from a user and/or an approval from a resource 210 authenticated by the user) at the first and/or the second device 202. The access managers 204 at the first and/or second devices 202 may inform (e.g., via a secure messaging service 214) each other of the result of the request for the approval (e.g., approval has been granted, approval has been denied). For example, an access manager 204 on the first device 202 may initiate a request for an approval from a user and/or resource 210 at the second device 202. The user and/or resource 210 may grant the request (e.g., for approval to access the credentials 212 in the first device 202) at the second device 202 by providing biometric information (e.g., a voice signal, a retinal pattern, a face image), for instance. Hence, the access manager 204 on the second device 202 may inform the access manager 204 on the first device 202 of the result of said request for approval. In some embodiments, the access manager 204 on the second device 202 may not inform the access manager 204 on the first device 202 of the result of said request for approval.

In response to receiving the approval, the access manager 204 (of the first device) may access the information of credentials 212 from a secure store 206. In some embodiments, the access manager 204 can access and/or obtain the information of the credential 212 (e.g., a OTP code, a TOTP code, an authentication token, and/or other credentials) from a stream of messages of a messaging service (e.g., short message service (SMS)). In response to a failure to receive an approval, the access manager 204 may send and/or transmit a response denying the request for the credentials 212. For example, the user may overlook, ignore or deny a request for approval to access a credential 212 (e.g., a OTP code, a TOTP code, and/or other credentials) by the access manager 204 on a second device 202, for instance. Responsive to failing to receive the approval, the access manager 204 on the first device 202 may send and/or transmit a response denying the request (e.g., a message, a pop-up, a push notification, and/or other response) to the second device 202 via a secure messaging service 214 (e.g., a cloud-based messaging service) for instance.

In certain embodiments, the access manager 204 may transmit, send, and/or transfer the credentials 212 to another device 202 (e.g. the second device 202) to authenticate a user to access the resource 210. The information of credentials 212 may be transmitted via a secure messaging service 214, such as a cloud-based messaging service. For example, the access manager 204 on the first device 202 may transmit a TOTP code (or other credentials 212) to the access manager 204 on the second device 202. The transmitted TOTP code (or other credentials 212) may be used to authenticate a user to access a PaaS, IaaS, SaaS, and/or other resources 210.

The secure store 206 of the device 202 may be configured and/or designed to maintain and/or store information of a plurality of credentials 212. The secure store 206 may maintain and/or store the credentials 212 and/or generate the credentials according to the information maintained by the secure store 206. For example, the secure store 206 may maintain and/or store account identifiers, passwords, access tokens, keys, certificates, and/or other authentication credentials 212 for one or more resources 210. In another example, the secure store 206 may generate a TOTP code (or other credentials 212) using an account identifier and/or an access token (or other credentials), for instance. The secure store 206 may either be installed on the device 202 and/or accessible to the device 202 via an interface (e.g., a web browser). The secure store 206 can maintain and/or hold the information of the credentials 212 using volatile memory (e.g., RAM), non-volatile memory (e.g., HDD) or other magnetic or optical storage media, SSDs, virtual storage volumes (e.g., cloud storage), and/or other combinations or types of memory and/or storage. Some examples of a secure store 206 may comprise a secured keystore, a secured keychain, a secured truststore, a password management system, an SMS (secure) message stream, a device 202 specific storage, and/or other credential storage. The access manager 204 may interface or interoperate with the secure store 206 to access the credential(s) 212.

The credentials 212 stored, maintained, and/or generated by the secure store 206 can comprise a OTP code, an authentication token, a SSO code, a TOTP code, a password, a passphrase, a personal identification number, a security token or key, a software token or key, a certificate, and/or other credentials 212. The credential(s) 212 can comprise the credential(s) 212 of the user and/or the credential(s) 212 of the device 202. The authentication credentials 212 may comprise other types of temporary and/or time-synchronized passwords, codes, keys, tokens, and/or credentials. The credentials 212 may be one of a plurality of authentication factors (in multi-factor authentication) to authenticate the user to access the resource 210. For example, an account identifier, a personal identification number, and/or a OTP code may be associated with a resource 210, but only the account identifier (e.g., as a second factor) may be requested from the secure store (or second device) to authenticate the user to access the resource 210. The user may separately provide the account identifier and/or personal identification number (e.g., as a first factor) directly via the second device. The authentication factors and/or credentials 212 may be used to access a resource 210, approve a transaction and/or request, grant authorization, and/or execute other actions that require authentication. One or more authentication credentials 212 and/or factors may be required to access a resource 210 via a device 202. For example, a second device 202 may request an account identifier and a TOTP code (or any other credentials) from a first device 202 to access a resource 210. The credential(s) 212 may be sent, transmitted, and/or exchanged between multiple devices 202.

The browser agent 208 included in the (second) device 202 may be configured and/or designed to expand, enhance, and/or add functionality to a web browser. The browser agent 208 may comprise a module, a plug-in, an add-on, an extension, a software object, a toolbar, a browser helper object (BHO), and/or other tools that expand the functionality and/or flexibility of the web browser. In certain embodiments, the browser agent 208 may provide, populate, and/or fill-in the authentication credentials 212 (received from another device) that are required to access a resource 210 via a device 202. For example, a user may attempt to access a resource 210 and/or application (e.g., a web application, a URL, a webpage) via the device 202. The resource 210 and/or application may require authentication credentials 212 to obtain access to the resource 210. The browser agent 208 (e.g., a web browser extension and/or a browser helper object (BHO)) may determine that an authentication credential 212 (e.g., an OTP code, a TOTP code, a SSO code, and/or other credentials) is requested by the resource 210. Hence, the browser agent 208 may obtain, populate and/or fill-in the information of the authentication credentials 212 (e.g., forms fields, browser cookies, and/or other authentication data) in the device 202 and/or resource 210. The browser agent 208 may access and/or obtain the information of the credentials 212 via another device 202 (e.g., from the secure store 206).

A resource 210 included in and/or accessible to the device 202 can comprise a cloud computing service application, an IaaS application, a PaaS application, a SaaS application, a web application, a workspace, a remote-hosted network application, and/or other resources 210 or applications. In some embodiments, the resource 210 may be referred to interchangeably with a web resource, an application, an application resource, or a network application. In some embodiments, the user and/or device 202 may be authenticated prior to accessing the resource 210. The resources 210 may be accessed by the device 202 via an interface (e.g., a gateway service, a web browser, a workspace application or manager). The resource 210 may be installed on the device 202 and/or may be executed or accessed using an interface (e.g., a web browser, or an interface of the resource 210). In some embodiments, the resource 210 may comprise an application that provides an interface (e.g., workspace application/manager) enabling access to other resources and/or applications (e.g., SaaS applications, web applications, files, virtual applications, desktops, mobile applications, local applications, and/or other resources 210). In certain embodiments, when a second device 202 attempts to access a resource 210, the resource 210 may communicate with the access manager 204 (or another device 202 component) to verify or determine if the authentication credential(s) 212 are stored within the second device 202. Responsive to the absence of the authentication credential(s) 212 within the second device 202, the resource 210 and access manager 204 may communicate with each other to obtain, access, and/or request the authentication credential(s) 212. In response to the presence of the authentication credential(s) 212 within the second device 202, the resource 210 may obtain the authentication credential(s) 212 from the access manager 204, the secure store 206, and/or another device 202 component.

A list of available resources 210 may, for example, be presented on a user interface (e.g., workspace application/manager) of the device 202 as a set of selectable icons or other elements corresponding to accessible resources 210. The resources 210 so identified may, for example, include one or more virtual applications and/or desktops, one or more file repositories and/or file sharing systems, one or more secure browsers, one or more internet enabled devices or sensors, one or more local applications installed on the device 202, and/or one or more SaaS applications to which the user and/or device 202 has subscribed.

The system 200 may include one or more secure messaging services 214. The secure messaging service(s) 214 may be configured and/or designed to send, transmit, transfer, relay, exchange, and/or receive requests, authentication credentials 212, and/or other data. The access manager(s) 204 on multiple devices 202 may communicate, transfer, exchange, and/or transmit authentication data between the devices 202 via the secure messaging service 214. In some embodiments, the access manager(s) 204 may receive the request to access an authentication credential 212 via the secure messaging service 214. The access manager(s) 204 may transmit, route, direct, and/or send the authentication credential(s) 212 via the secure messaging service. Some examples of a secure messaging service 214 may include a cloud-based messaging system, a secured text-based messaging system, a secured wired/wireless network, a push notification system, a secured notification service, and/or other services or systems.

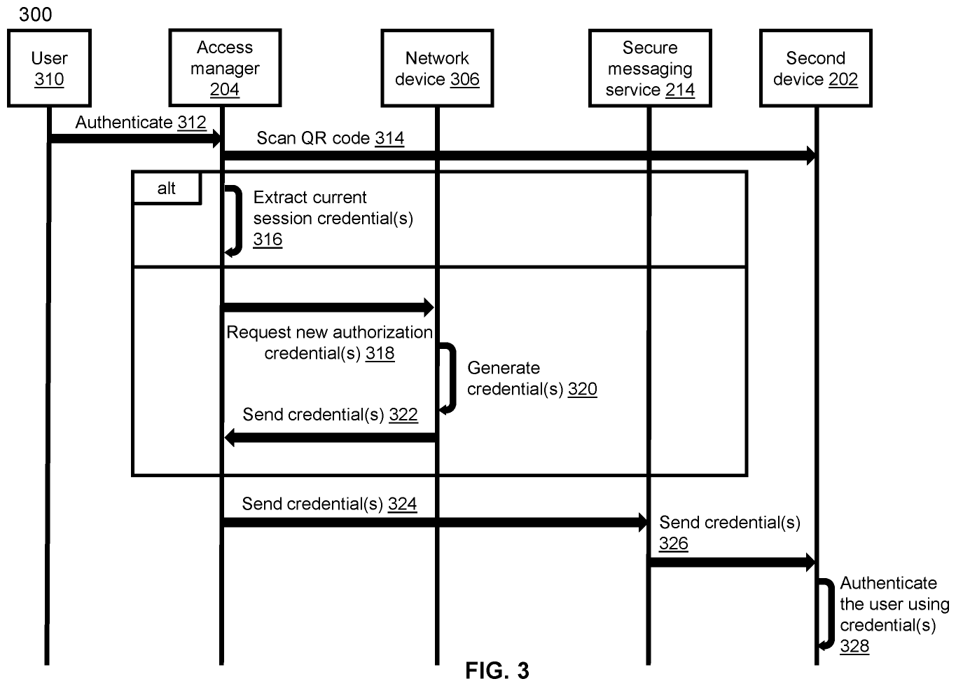

Referring now to FIG. 3, depicted is a communication diagram of an embodiment for a process 300 for transferring information related to the credentials during an authenticated session. Under process 300, the user 310 may complete an authentication process to access the resource 210 via a second device 202 using the access manager(s) 204 on a first device 202 (312). The authentication credential(s) 212 may be stored and/or maintained in the secure store 206 accessible to the first device 202. The access manager 204 on the first device 202 may establish a trusted connection and/or communication with the second device 202 (314). The trusted and/or secured connection may enable the secure transmission or sharing of authentication information and/or credentials 212. For instance, the access manager(s) 204 on the first device 202 may scan a QR code on the second device 202 to enable a trusted connection to be established (314).

Once the trusted connection is established, the access manager 204 may extract and/or access the authentication credential(s) 212 from the secure store 206 (316). In other embodiments, the secure store 206 (or other device 202 components, such as the access manager 204) may generate, be caused to generate, and/or cause another component to generate the authentication credential(s) 212. For example, the access manager 204 may send a request to a network device 306 (e.g., a NetScaler Gateway Service (NGS)) to generate new authentication credential(s) 212 (318). Responsive to the request, the network device 306 may generate and provide the authentication credential(s) 212 (320). Once the authentication credential(s) 212 are generated, the network device 306 may send, transmit, and/or transfer the authentication credential(s) 212 to the access manager 204 on the first device 202 (322). In response to receiving the authentication credential(s) and/or extracting the authentication credential(s) 212 from the secure store 206, the access manager 204 may send and/or transmit the credential(s) 212 via the secure messaging service 214 (324). The second device 202 may therefore receive the authentication credential(s) 212 via the secure messaging service 214 (326). Once the second device 202 receives the authentication credential(s) 212, the second device 202 may authenticate the user 310 using the authentication credential(s) 212 to access the resource 210 via the second device 212 (328).

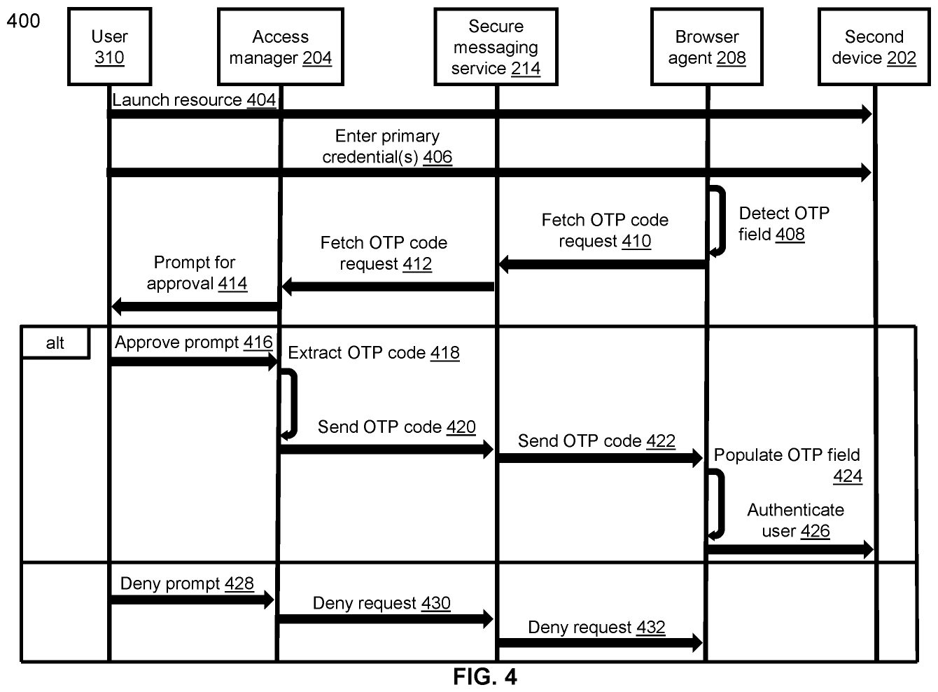

Referring now to FIG. 4, depicted is a communication diagram of an embodiment for a process 400 for transferring information of credentials to a second device 202. Under process 400, the user 310 may launch, execute, and/or attempt to access a resource 210 via a second device 202 (404). The user 310 may enter and/or provide one or more primary credential(s) 212 (e.g., an account identifier, and/or a password) to the second device 202 to access the resource 210 (406). Once the primary credential(s) 212 are provided, a browser agent 208 may interact and/or communicate with the resource 210 (or access manager(s) 204) and detect and/or determine that the resource 210 is to be accessed using additional authentication credential(s) 212 (e.g., a OTP code) (408). In response to determining that additional authentication credential(s) 212 are to be provided, the browser agent 208 may send, fetch, transfer, and/or transmit a request for the credential(s) 212 to the access manager 204 via the secure messaging service 214 (410). The access manager 204 may receive the request for the credential(s) 212 via the secure messaging service 214 (412).

Responsive to receiving the request for the authentication credential(s) 212, the access manager 204 may initiate a request for an approval by sending a prompt to the user 310 (414). The approval can comprise an approval to access, extract, and/or transfer the authentication credential(s) 212 from the secure store 206. In some embodiments, the user 310 may provide an approval at the first device 201 (416). Therefore, the access manager 204 may receive the approval by the user 310 (416). Once the access manager 204 receives the approval, the access manager 204 may extract the authentication credential(s) 212 from the secure store 204 (418). The access manager(s) 204 may send, transmit, and/or transfer the authentication credential(s) 212 to the browser agent 208 via the secure messaging service 214 (420). The browser agent 208 may receive the authentication credential(s) 212 via the secure messaging service 214 (422). Responsive to the browser agent 208 obtaining the authentication credential(s) 212, the browser agent 208 may fill-in, populate, and/or provide the additional authentication credential(s) 212 for authentication to access the resource 210 (424). The second device 202 may then complete the authentication process and the user 310 may access the resource 210 (426).

In other embodiments, the user 310 may deny (or overlook or ignore) the request for an approval at the device 202 (428). For instance, the access manager 204 may receive a response denying the approval for the authentication credential(s) 212 (428). The access manager(s) 204 may send a message (denying the request for secondary credential(s)) to the browser agent 208 via the secure messaging service 214 (430). The browser agent 208 may receive the message denying the request via the secure messaging service 214 (432).

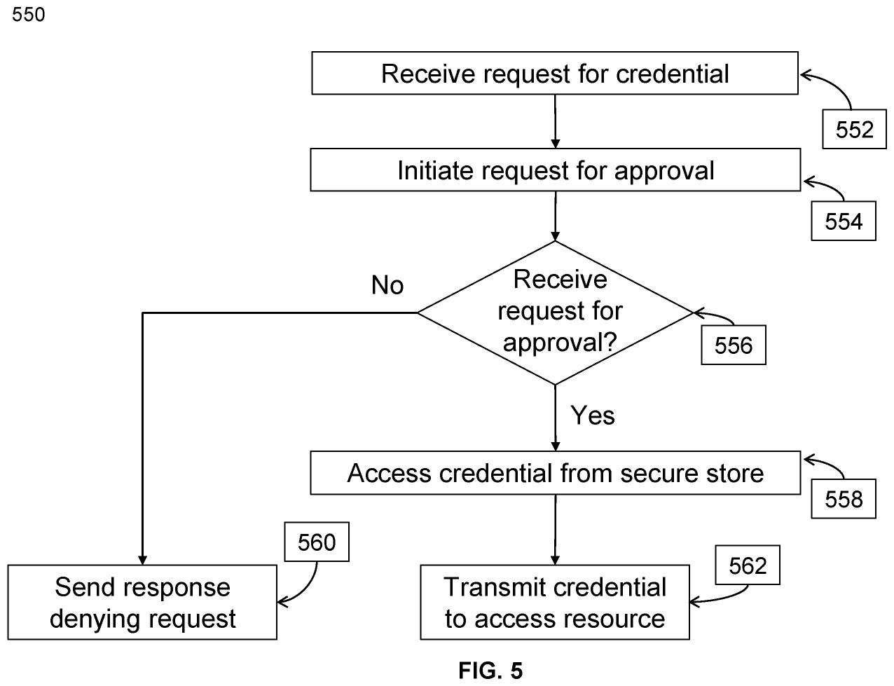

Referring to FIG. 5, depicted is a flow diagram of one embodiment of a method (550) for sharing authentication information to access a resource. The operations and functionalities of the method 550 may be performed by any one or more of the components described in FIGS. 1A-4, such as the system 200 as detailed herein in conjunction with FIGS. 3 and 4. In brief overview, an access manager 204 on a second device 202 may receive a request for a credential (552). The access manager 204 may initiate a request for approval at a first device 202 or the second device 202 (554). The access manager 204 may or may not receive the request for approval (556). If the access manager 204 receives the request for approval, the access manager 204 may access the credential(s) 212 maintained with (e.g., stored or located at, or generated by) the secure store 206 (558). The access manager 206 may transmit the credential(s) 212 to access the resource(s) 210 (562). If the access manager 204 fails to receive the request for approval, the access manager 204 may send a response denying the request (560).

In certain embodiments, a user may attempt to access a resource 210 via a second and/or third device 202. The resource 210 may be accessed using authentication credentials 212 maintained and/or stored at a first device 202. For example, the access manager(s) 204 (e.g., workspace manager/application) of the second and/or third device 202 may interact and/or communicate with a secure store 206 of the second and/or third device 202, and may determine that the authentication credentials 212 are absent from the second and/or third device 202. Responsive to determining the absence of the authentication credentials 212 for instance, the access manager 204 on the second and/or third device 202 may communicate with an access manager 204 of the first device 202. The access manager 204 of the first device 202 may interact with a secure store 206 of the first device 2020, and may determine that the authentication credentials 212 are available, stored and/or maintained at the first device 202. In some embodiments, the access manager 204 of the first device 202 may communicate to the access manager 204 on the second and/or third device 202 that the authentication credentials 212 are stored and/or maintained at the first device 202. The access manager 204 of the second and/or third device 202 may send a request for the authentication credentials 212 to the access manager 204 of the first device 202. In some embodiments, the access manager 204 of the first device 202 may communicate directly with the secure store 206 of the first device 202 to determine the availability, presence or absence of the authentication credentials 212. In yet another embodiment, a browser agent 208 (which may be an access manager 204 of the second device 2020) may detect that the authentication credentials 212 are to be obtained and used to access a resource 210 via the second device 202. The browser agent 208 may send a request for the authentication credentials 212 to the access manager 204 of the first device 202. The access manager 204 on the first device 202 may receive the request for the authentication credentials 212 from the browser agent 208.

In certain embodiments, the devices 202 may establish a trusted connection enabling the transfer, communication, transmission, and/or exchange of requests, approvals, credentials 212, and/or other data between the devices 202. For instance, the device(s) 202 may prompt for approval (e.g., from the user, or an authenticated device or application) so that a trusted connection is established. If the devices 202 establish a trusted connection, the access manager(s) 204 may be configured to allow the automatic transfer of the authentication credentials 202 and/or other data. For example, the access manager(s) 204 of the second and/or third device 202 may have approval to communicate directly with the access manager 204 and/or secure store 206 of the first device 202 to access and/or obtain the authentication credentials 212. In other embodiments, the devices 202 may prompt for approval to access and/or obtain the authentication credentials 212, even though a trusted connection is already established. For example, the access manager(s) 204 of the devices 202 may have established a trusted connection, but may prompt (e.g., a user) for approval prior to sending and/or accessing the authentication data.

The devices 202 may establish the trusted connection for instance by determining or establishing proximity between the devices 202 (e.g., using software beacons on the devices 202), scanning a QR code (e.g., the second device 202 scans a QR code on the first device 202), and/or other mechanisms discussed herein. The access manager 204 of the first device 202 may receive a request from the credentials 212 via a secure messaging service 214. In response to the request for the credentials 212, the access manager 204 of the first device 202 may initiate a request for an approval (e.g., at the first, second, and/or third device 202) to establish the trusted connection and/or to provide the requested credentials 212 to the second device 202.

Referring now to operation (552), and in some embodiments, the access manager 204 may receive a request for a credential 212. The access manager(s) 204 on a first device 202 may receive a request for the credential 212 from (e.g., maintained or generated at) the first device 202. The request for the credential 212 may be to access a resource 210 via another device 202 (e.g., a second device 202 and/or a third device 202). The first and second devices 202 may be operated by a user (e.g., a user operates a mobile device and a laptop computer). The access manager 204 of the first device 202 may receive the request from the access manager 204 of another device 202.

Referring now to operation (554), and in some embodiments, the access manager 204 of the first device 202 may initiate a request for approval at the device 202. The access manager 204 of the first device 202 may initiate a request for approval to establish the trusted connection and/or to provide the requested credentials 212 to the second device 202. Responsive to the request for the credential(s) 212, the access manager 204 may initiate a request (e.g., a second and/or fourth request) for an approval at the device 202 (e.g., the first, second, and/or third device 202). The request for an approval may include an approval from the user and/or an approval from a resource 210 authenticated by the user (e.g., an application or device already authenticated with the user). In some embodiments, the request for an approval may comprise a request to approve the access and/or transmission of the information of the credentials 212. The request for an approval may comprise a prompt to the user to provide the approval at the device 202.

For example, the access manager 204 on the first device 202 may receive the request for the credential(s) 212 from the second device 202. In response, the first device 202 may prompt the user to approve the request via the second device 202 (or other device 202). The approval may comprise an approval via (e.g., the user providing) a pin, a passcode, a fingerprint, a badge tap, a face image, a QR code scan, a device unlock operation, a voice signal, proximity to the devices 202, a user interface selection, and/or other mechanisms of approval. For example, the user may be prompted to provide a biometric marker (e.g., a retinal pattern, a face image, and/or other biometric markers) to constitute, enable or otherwise provide approval at the first device 202. In another example, the user may be prompted to provide an authentication factor (e.g., a password) via a voice signal to provide approval at the second device 202. In some embodiments, the access manager 204 of the first device 202 may have a trusted connection and/or communication with the access manager(s) 204 on one or more devices 202. Therefore, the access manager(s) 204 on the device 202 may be configured to determine that the request for the approval is unnecessary.

Referring now to operation (556), and in some embodiments, the access manager 204 may or may not receive the request for approval. In response to initiating the request for an approval, the access manager 204 may receive approval to access and/or transmit the authentication credentials 212. If the access manager 204 receives approval, the access manager 204 may obtain or access the authentication credential(s) 212. The access manager 204 may interface and/or communicate with the secure store 206 to access the authentication credential(s) 212. In some embodiments, the access manager(s) 204 may fail to receive approval to access and/or transmit the authentication credentials 212. For example, the user may deny to provide approval via the authentication factor(s) at the device 202. In another example, the user may provide incorrect, invalid, and/or unverified authentication factor(s) at the device 202, which cannot constitute an approval. If the access manager(s) 204 fails to receive the approval, the access manager 204 may send a response denying the request for the authentication credentials 212. In some embodiments, the access manager(s) 204 on the device 202 (e.g., the first device 202) may send a response denying the request for the authentication credential(s) 212 to the access manager(s) 204 on the other device(s) (e.g., the second and/or third devices 202). In certain embodiments, the access manager(s) 204 may determine to resend and/or reinitiate the request for the approval at the device 202. Following one or more failures to receive the approval, the device 202 may decide to terminate and/or prohibit a trusted connection between the devices 202. The above discussed response(s), request(s), and/or approval(s) may be sent using the secure messaging service 214.

Referring now to operation (558), and in some embodiments, the access manager 204 may access the credential(s) 212 maintained with the secure store 206. Responsive to receiving the approval, the access manager 204 may access the credential(s) 212 from the secure store 206. In some embodiments, the access manager 204 may signal and/or communicate the approval to the secure store 206. The secure store 206 may then provide the access manager 204 with: access to the credential(s) 212, the credential(s) 212 themselves, and/or information to generate the credential(s) 212. The secure store 206 may securely maintain, store, generate, and/or have access to information of a plurality of credentials 212. The credential(s) may comprise the credential(s) of the user and/or the credential(s) of the device 202. The plurality of credentials 212 may be utilized and/or requested by one or more resources 210 or for access to the one or more resources 210. Accessing the credential(s) 212 from the secure store 206 may comprise accessing the credentials 212 that are stored and/or maintained in the secure store 206. Accessing the credential(s) 212 from the secure store 206 can comprise causing the secure store 206 to generate the credential(s) 212 according to the information maintained by the secure store 206. For example, the access manager 204 may extract the current session credential(s) 212 from the secure store 206 and/or generate new session credential(s) 212 (e.g., via a network device, for example). The credentials 212 can comprise a OTP code, an authentication token, a SSO code, a TOTP code, and/or other credentials 212. The credential 212 may be one of a plurality of authentication factors to authenticate the user to access the resource 210. For example, the secure store 206 can maintain, store, and/or have access to an authentication token, an account identifier, and/or a TOTP code to access the resource 210 via the device 202. The access manager 204 on the device 202 may access one or more of the authentication credentials 212 from the secure store 206 for authentication purposes. In some embodiments, the access manager 204 can access and/or obtain the information of the credentials 212 from a message or a stream of messages of a messaging service (e.g., SMS messages). In response to accessing the credential(s) 212, the access manager 204 may transmit the credential(s) 212 to another device 202 (e.g., to the second and/or third device 202).

Referring now to operation (562), and in some embodiments, the access manager 204 may transmit the credential(s) 212 to access the resource(s) 210. The access manager 204 of the device 202 (e.g., the first device 202) may transmit the credential(s) 212 to the other device(s) 202 (e.g., the second and/or third device 202) to authenticate a user to access the resource(s) 210. The access manager 204 of the first device 202 may transmit the credential(s) 212 to the access manager(s) 204 and/or secure store(s) 206 of the other device(s). The access manager(s) 204 of the other device(s) 202 may receive the credential(s) and communicate, transfer, and/or send them to an authentication process for accessing the resource(s) 210. The resource(s) 210 may utilize the credential(s) 212 to authenticate the user and access the resource(s) 210. In other embodiments, the access manager(s) 204 may store the received credential(s) 212 in the secure store(s) 206. The resource(s) 210 and/or access manager(s) 204 may interface and/or communicate with the secure store(s) 206 to access, utilize, and/or update the information of the credential(s) 212. If the transmitted credential(s) 212 are invalid and/or outdated, the access manager(s) 204 may send a request to the user for updated credential(s) 212. In other embodiments, if the received credential(s) 212 are invalid, the access manager(s) 204 may send a request for the credential(s) 212 to other devices 202 that may have valid credential(s). The access manager 204 of the first device 202 may transmit and/or send the credential(s) 212 to the second and/or third devices 202 via the secure messaging service 214. In some embodiments, the access manager 204 may transmit the credential(s) 212 to a browser agent 208 of the second and/or third devices 202. The browser agent 208 may populate and/or fill-in the authentication credential(s) 212 (e.g., forms fields, browser cookies, and/or other authentication data) for authentication to be performed to access the resource 210.

Referring now to operation (560), and in some embodiments, the access manager 204 may send a response denying the request. Responsive to the failure to receive the approval, the access manager(s) 204 may send a response denying the request for the authentication credential(s) 212. The user may deny the prompt to provide the approval, for example by ignoring the prompt or declining to provide a personal identification number (or other credential(s) 212) as requested by the prompt. Therefore, the first device 202 may send a response to the second device 202 denying the request for the authentication credential(s) 212. For instance, the access manager 204 of the first devices 202 may communicate or send, the response denying the request for the authentication credential(s) 212 via a secure messaging service 214, and the response may be delivered or presented in a pop-up, a push-notification, a text message, and/or other messaging mechanism.

Various elements, which are described herein in the context of one or more embodiments, may be provided separately or in any suitable subcombination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, USB Flash memory, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C #, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

What is claimed is:

1. A method comprising:
receiving, by an access manager on a first device, a first request for a credential maintained at the first device, to access a resource via a second device;
initiating, by the access manager responsive to the first request, a second request for an approval at the first device or the second device;
accessing, by the access manager responsive to receiving the approval, the credential from a secure store, the secure store securely maintaining information of a plurality of credentials; and
transmitting, by the access manager, the credential to the second device to authenticate a user to access the resource.

2. The method of claim 1, wherein the first device and the second device are operated by the user.

3. The method of claim 1, wherein the second request comprises a prompt to the user to provide the approval at the first device or the second device.

4. The method of claim 1, wherein the approval comprises an approval via a pin, a passcode, a fingerprint, a badge tap, a face image, a QR code scan, a device unlock operation, a voice signal, proximity to the first or second device, or a user interface selection.

5. The method of claim 1, comprising:
receiving, by the access manager, the first request via a secure messaging service; and
transmitting, by the access manager, the credential to the second device via the secure messaging service.

6. The method of claim 1, wherein accessing the credential from the secure store comprises accessing the credential that is stored in the secure store, or causing the secure store to generate the credential according to the information maintained by the secure store.

7. The method of claim 1, comprising:
receiving, by the access manager a third request for a second credential maintained at the first device, to access a second resource via a third device;
initiating, by the access manager responsive to the third request, a fourth request for a second approval at the first device; and
sending, by the access manager responsive to a failure to receive the second approval, a response denying the third request for the second credential.

8. The method of claim 1, wherein the credential comprises a one-time password (OTP) code, an authentication token, a single sign-on (SSO) code, or a time-based OTP (TOTP) code.

9. The method of claim 1, wherein the credential is one of a plurality of authentication factors to authenticate the user to access the resource.

10. A first device, comprising:
at least one processor configured to:
receive a first request for a credential maintained at the first device, to access a resource via a second device;
initiate, responsive to the first request, a second request for an approval at the first device or the second device;
access, responsive to receiving the approval at the first device, the credential from a secure store, the secure store configured to securely maintaining information of a plurality of credentials; and
transmit the credential to the second device to authenticate a user to access the resource.

11. The first device of claim 10, wherein the first device and the second device are operated by the user.

12. The first device of claim 10, wherein the second request comprises a prompt to the user to provide the approval at the first device or the second device.

13. The first device of claim 10, wherein the approval comprises an approval via a pin, a passcode, a fingerprint, a badge tap, a face image, a QR code scan, a device unlock operation, a voice signal, proximity to the first or second device, or a user interface selection.

14. The first device of claim 10, wherein the at least one processor is configured to:
receiving, by the access manager, the first request via a secure messaging service; and
transmitting, by the access manager, the credential to the second device via the secure messaging service.

15. The first device of claim 10, wherein the at least one processor is configured to access the credential from the secure store by: accessing the credential that is stored in the secure store, or causing the secure store to generate the credential according to the information maintained by the secure store.

16. The first device of claim 10, wherein the at least one processor is configured to:
receive a third request for a second credential maintained at the first device, to access a second resource via a third device;
initiate, responsive to the third request, a fourth request for a second approval at the first device; and
send, responsive to a failure to receive the second approval, a response denying the third request for the second credential.

17. The first device of claim 10, wherein the credential comprises a one-time password (OTP) code, an authentication token, a single sign-on (SSO) code, or a time-based OTP (TOTP) code.

18. The first device of claim 10, wherein the credential is one of a plurality of authentication factors to authenticate the user to access the resource.

19. A non-transitory computer readable medium storing program instructions for causing at least one processor of a first device to:
receive a first request for a credential maintained at the first device, to access a resource via a second device;
initiate, responsive to the first request, a second request for an approval at the first device or the second device;
access, responsive to receiving the approval, the credential from a secure store, the secure store securely maintaining information of a plurality of credentials; and
transmit the credential to the second device to authenticate a user to access the resource.

20. The non-transitory computer readable medium of claim 19, wherein the program instructions cause the at least one processor to:
receive the first request via a secure messaging service; and
transmit the credential to the second device via the secure messaging service.
